(19) United States
(12) Patent Application Publication
(10) Pub. No.: US 2026/0010767 A1
(43) Pub. Date: Jan. 8, 2026

(54) EFFICIENT EXECUTION OF MACHINE LEARNING MODELS ON SPECIALIZED HARDWARE

(71) Applicant: Roche Sequencing Solutions, Inc., Pleasanton, CA (US)

(72) Inventors: Ganesh BIKSHANDI, Fremont, CA (US); Charles SEBERINO, Gilbert, AZ (US)

(21) Appl. No.: 19/330,406

(22) Filed: Sep. 16, 2025

Related U.S. Application Data
(63) Continuation of application No. PCT/US2024/020863, filed on Mar. 21, 2024.
(60) Provisional application No. 63/453,827, filed on Mar. 22, 2023.

(51) Int. Cl. G06N 3/0464

(52) U.S. Cl. CPC G06N 3/0464

(57) ABSTRACT

Systems and methods of executing a machine learning model on a specialized computing device can comprise obtaining raw input data by a first computing device; obtaining the machine learning model including a function that applies a set of M model parameters to at least one channel of the raw input data; determining a configuration parameter K for the specialized computing device; configuring the raw input data based on the configuration parameter to obtain configured input data; configuring the machine learning model based on the configuration parameter to obtain a configured machine learning model with a configured model dimension corresponding to the data size of the acceleration path; executing the configured machine learning model with the configured model parameter using the configured input data to obtain output data; and providing the output data.

### CROSS REFERENCE TO RELATED APPLICATIONS

This application is a bypass continuation of International Appln. PCT/US2024/020863 filed Mar. 21, 2024, which claims priority to U.S. Provisional Application No. 63/453,827, filed Mar. 22, 2023, which are herein incorporated by reference in their entireties for all purposes.

### BACKGROUND

Machine learning, especially deep learning and artificial neural networks (ANNs), has become more and more useful for modern scientific research and industrial applications to perform big-data analysis and make data-driven decisions. These ANNs are of great help in providing classification and prediction in many disciplines such as computer science, electronic engineering, and biology. ANN models, including convolutional neural network (CNN) models, are often trained in a manner that limits the adaptability of the trained models to suit different user needs. For example, it is often difficult to utilize the acceleration paths of specialized hardware, such as tensor cores of graphics processing unit (GPU), to execute the trained models.

Some existing solutions include adding additional layers in CNN models, creating pitched memory copies, or retraining CNN models with special needs. These solutions nevertheless increase computation and memory needs, reduce calculation speed and efficiency, and are impractical under many situations.

### BRIEF SUMMARY

The present disclosure relates generally to executing machine learning models on specialized computing devices, and more specifically, to embodiments that can configure data of various sizes and dimensions and model of various types to be suitable to execute on various acceleration paths of the specialized computing devices. For example, some embodiments can reshape data and replicate or readjust functions (e.g., filters of a CNN model) based on a requirement regarding the use of an acceleration path of a specialized computing device. Various techniques can be used to configure data and models, so that the execution of the configured models with the configured data can be performed on the acceleration paths of the specialized computing device and a computational efficiency can be achieved.

These and other embodiments of the disclosure are described in detail below. For example, other embodiments are directed to systems, devices, and computer readable media associated with methods described herein.

A better understanding of the nature and advantages of embodiments of the present disclosure may be gained with reference to the following detailed description and the accompanying drawings.

### BRIEF DESCRIPTION OF THE DRAWINGS

FIG. 1 illustrates a block diagram of an example system 100 for obtaining data and configuring data and machine learning models to be used for calculations, predictions, and classifications in a specialized computing device, according to various embodiments of the present invention.

FIG. 2 shows a flow chart 200 illustrating an example method of configuring raw input data and machine learning models according to various embodiments of the present invention.

FIG. 3A illustrates exemplary raw sequencing data obtained at block 210 in FIG. 2 according to certain embodiments.

FIG. 3B illustrates exemplary pre-processed sequencing data according to certain embodiments.

FIG. 4A illustrates exemplary raw sequencing data with a filter of a CNN model according to certain embodiments.

FIG. 4B illustrates exemplary three-dimensional raw input data with a filter of a CNN model according to certain embodiments.

FIG. 5 illustrates an example of performing convolution on the raw input data using a channel of a filter in a convolutional layer of a CNN model according to certain embodiments.

FIG. 6 illustrates an example of performing convolution on the raw input data using multiple filters in a convolutional layer of the CNN model according to certain embodiments.

FIG. 7A illustrates an exemplary visualization of configuring three-dimensional raw input data to be suitable for executing on an acceleration path of a GPU according to certain embodiments.

FIG. 7B illustrates another exemplary visualization of configuring three-dimensional raw input data to be suitable for executing on an acceleration path of a GPU according to certain embodiments.

FIG. 8 illustrates three examples of configuring raw input data according to various embodiments.

FIGS. 9A and 9B illustrate two exemplary ways of configuring a filter in a CNN model to be executed on an acceleration path of an 8-channel GPU using configured input data according to certain embodiments.

FIGS. 10 and 11 show exemplary execution of configured models on configured data according to certain embodiments.

FIG. 12 illustrates an example of a physical computing environment according to certain embodiments.

FIG. 13 shows a block diagram of an example computer system usable with system and methods according to certain embodiments.

### DETAILED DESCRIPTION

Techniques disclosed herein relate to automatic transforming and analyzing raw input data, including sequencing data generated from sequencing devices, to fit a variety of machine learning models and specialized hardware that efficiently performs calculations, predictions, and classifications. Different sequencing devices can generate raw sequencing data, and the raw sequencing data may be pre-processed to provide raw input data to be used in machine-learning models for further analysis. The raw input data and the machine learning models may be configured in specialized hardware that has acceleration paths. To utilize the acceleration paths of the specialized hardware, for example, tensor cores of a Graphic Processing Unit (GPU), the raw input data and the machine learning models need to be of specific configurations. However, machine learning models are usually trained in a regular computing system that does not have any specialized hardware or does not consider any configurations of specialized hardware.

To address the issue, embodiments described herein provides methods and techniques to configure raw input data and machine learning models to execute the machine learning models on acceleration paths of specialized computing devices. In some cases, data are configured to have a required number of dimensions and functions (e.g., filters of CNN models). For example, functions can be replicated and readjusted to fit the number of dimensions based on the requirement regarding the use of an acceleration path of a specialized computing device. Various techniques can be used to configure data and models, so that the execution of the configured models with the configured data can be performed on the acceleration paths of the specialized computing device and a computational efficiency can be achieved.

### I. Deep Learning Networks and Specialized Computing Device

Machine learning is a key concept in the field of artificial intelligence, and has been used and developed in a variety of industries, such as biotechnology and pharmaceuticals. Deep learning, a sub-area of machine learning, which performs model classification through multiple layers or levels, becomes more and more popular in providing useful and accurate classification information in biotechnology and pharmaceuticals. Deep learning models are usually trained using a neural network architecture such as an artificial neural network (ANN) or a convolutional neural network (CNN). Different information is extracted through different layers in such neural networks and combined to use for prediction or classification. For example, deep learning models can be trained using image data to predict a location of an object in the image. They can also be trained using sequencing impulse (signal) data to improve the accuracy of base-calling in a sequencing process.

However, machine learning (ML) models can be comptuationally expensive to run. For this reason, specialized hardware has been developed to execute such models. For example, graphical processing units can be used to efficiently execute machine learning models. But even using specialized hardware, the large size of a data set can require an ML model to run for a long time. This can be particularly true when the specialized hardware is not able to perform optimally. Embodiments described herein can rearrange data and an ML model to operate more efficiently, e.g., to make use of an acceleration path in a more consistent manner. Some example ML models are mentioned below, along with some example descriptions of specialized hardware.

### A. Convolutional Neural Networks and Other Deep Learning Networks

CNNs are commonly used deep learning models when the input data are images or signal data and the output is a classification or prediction regarding the image or signal data. CNNs are useful and popular in the area of biology and biotechnology, partially because the CNNs are inspired and designed to resemble neurons interacting within a biological system. A typical CNN consists of an input layer, multiple hidden layers where the convolution is performed, and an output layer.

Filters (or kernels) are the key concept in CNNs. In a CNN model, input data, including image data or signal data, are usually transformed into matrices. Similarly, filters in the CNN model are matrices of a certain size. Sometimes a filter is a 3×3 matrix, a 5×5 matrix, a 7×7 matrix, a 1×3 matrix, a 1×5 matrix, or a 1×7 matrix. In such instances, the filter is a two-dimensional filter (2D filter). In some instances, the dimension of a filter can be more than two. For example, a filter to an RGB image input is usually three-dimensional. The filters in the CNN model help extract specific features from the input data, for example, a peak of a signal, or vertical edges of an image. The basic mechanism of filters' feature extraction is performed by overlapping a filter matrix with an input matrix, multiplying overlapped entries, and adding all multiplications together to get a new value.

The process of overlapping, multiplying, and adding is repeated by moving the filter matrix through the input matrix based on a predetermined stride to produce a feature matrix. The output of one layer in the CNN model—the feature matrix—is the basis of the input of the next layer in the CNN model. The training process of a CNN model learns the value of each entry of the filter matrix, and the filters in each layer become parameters of the CNN model. With the help of filters, CNN models are able to perform complex classification and prediction tasks. Below are some examples of CNN models (or CNN architectures) that can be used in data training and model classification by researchers or industrial practitioners. Many ML models, including the following CNN models, are suitable for the methods and systems disclosed herein.

A Residual Neural Network (ResNet) model is one of the most commonly used CNN architectures. Studies have found that traditional deeper-layers CNN models result in higher training error rates and overfitting than less deep CNN models. The ResNet model resolves the problem by employing residual blocks and skip connections to jump over some layers and avoid overestimation. Typical ResNet models are implemented with double-or triple-layer skips.

GoogLeNet is a 22-layer (27 layers in total including the pooling layers) CNN architecture to perform classification tasks. The GoogLeNet model has a notably reduced error rate and achieves deeper architecture by employing a variety of distinct techniques, including 1×1 convolution and global average pooling. As such, a GoogLeNet architecture is relatively computationally expensive. To reduce the number of necessary parameters, the GoogLeNet model uses heavy un-pooling layers on top of regular CNNs to remove spatial redundancy during training.

LeNet is a representative of the early CNN architecture. LeNet architectures often consist of multiple convolutional and pooling layers, followed by one or more fully connected layers. For example, a typical LeNet-5 model has seven layers: two convolutional layers, two pooling layers, and a dense block consisting of three fully connected layers.

Deep learning networks have a great span of applications in a variety of areas such as automatic speech recognition, image recognition, natural language processing, drug discovery and toxicology, medical image analysis, and bioinformatics. CNN models are not the only techniques to be applied in these areas, other ANN models, such as Deep Neural Network (DNN) models and Recurrent Neural Network (RNN) models can also be deployed to solve problems in the above-mentioned areas. They are also suitable for the techniques described herein.

### B. Specialized Computing Devices

Traditionally deep learning network models, including CNN models, are executed on a general computing device, for example, a central processing unit (CPU). However, executing deep learning network models on a CPU can be computationally intensive and both time-and cost-consuming. The trend nowadays is using specialized computing devices, such as graphics processing units (GPUs) or dedicated neural processing units (NPUs), to execute trained deep learning network models.

Graphics processing units (GPUs) are specialized processors that are used to accelerate graphics rendering and other graphical computations. They are commonly used in computer systems to improve the performance of applications that require complex graphics processing, such as video games, 3D modeling software, and scientific simulations. GPUs are believed to be particularly well-suited for deep learning network model execution due to their highly parallel architecture and specialized hardware for graphics rendering.

Many modern GPUs include tensor cores, which are specialized units that are designed to efficiently perform tensor computations, such as matrix multiplication. Tensor cores can significantly improve the performance of executing deep learning network models. However, many tensor cores have their specified prerequisites regarding the size and dimension of input data. When a trained deep learning network model is executed in a GPU, it may not be able to fully use the acceleration path, or the tensor cores of the GPU, thus may not achieve its best performance. For example, a ResNet model is generally trained using input data of three channels, while tensor cores in some GPUs require the number of input channels to be 8 or 16. When the input data size does not meet the prerequisites, the tensor cores are not used, and the execution will fall back on different cores that do not execute matrix multiplication faster. Embodiments described herein provide methods and techniques for configuring input data and deep learning network models to fit for execution on specialized computing devices.

### II. Measurements and Analysis Using Specialized Computing Device

Data and ML models can be configured and executed in specialized computing devices in many different ways. For example, in various embodiments, data are generated by a data generating device, such as a sequencer, collected by a data collection unit, and pre-processed by a data pre-processing unit. The pre-processed data can be configured according to a configuration parameter (such as a required input channel number that is a multiple of the configuration parameter, e.g., 8) that depends on a specialized computing device. Models can be collected by a model collecting unit and configured according to the same configuration parameter associated with the specialized computing device. The configured data and configured models can be executed by the specialized computing device through its acceleration path, and an output is provided by an output unit. There may also be many different ways to configure data and models and have them be executed by the specialized computing device through its acceleration path.

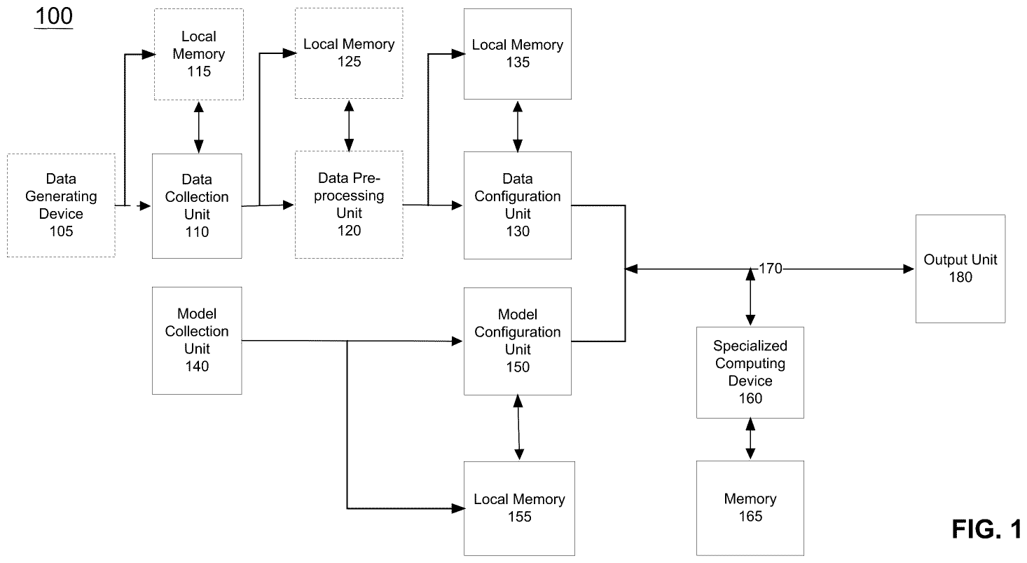

FIG. 1 illustrates a block diagram of an example system 100 for obtaining data and configuring data and machine learning models to be used for calculations, predictions, and classifications in a specialized computing device, according to various embodiments of the present invention. Any unit of the system 100 can be a personal computer or a part of a personal computer, such as a CPU or a GPU, or a unit as a part of a web-based server. In some instances, a data collection unit 110, a data pre-processing unit 120, a data configuration unit 130, a model collection unit 140, a model configuration unit 150, and an output unit 180 may be integrated on the same computer or on different computers. In some instances, a unit of the system 100 may be integrated on the same specialized computing device 160.

An optional block 105 may be a data generating device, such as a sequencing device, to generate raw data. When the data generating device 105 is a sequencing device, it may be a Sanger sequencer, a 454 DNA sequencer, a next-generation sequencing machine, a fluorescent microscopy sequencing device, a hydrogen ion measurement-based sequencing device, a nanopore-based sequencing device, or the like. In some instances, the data generating device 105 comprises a sensor. For example, a nanopore-based sequencing device can be a collection of analog circuitries making up different surface locations, wells, or cells. In some instances, the data generating device 105 comprises one or more photonic sensing devices, for example, cameras. Lidar, sonar, and radar measurement devices may also be used as the data generating device 105.

The generated raw data can be acquired by a data collection unit 110. In some instances, the data collection unit 110 collects raw input data from a data library. The collection function may be executed by a user input or according to a program saved in a local memory 115. The raw input data collected by the data collection unit 110 may be sequencing data or image data. In some embodiments, the raw input data may be saved to a local memory 115. The local memory 115 can be the same memory as in blocks 125, 135, 155, or 165.

The generated raw data acquired by a data collection unit 110 may be pre-processed by a data pre-processing unit 120 before any configuration. In some instances, the data pre-processing unit 120 may be the same as the data collection unit 110. The pre-processing process may be conducted according to programs in a local memory 125, or alternatively, the pre-processing process can be performed in a web-based server. In some embodiments, the local memory 125 can be the same memory as in blocks 115, 135, 155, or 165.

In some instances, the generated raw data may be normalized. The normalization may be based on channels or uniformly performed across channels. For example, in a case of fluorescent microscopy sequencing, specific wavelengths that excite fluorophore dyes attached to DNA nucleotides may be used to pre-process data. In some instances, the normalization is a time-based normalization (e.g., flattening). For example, when collecting a signal using a electronic circuitry device, a capacitive component may be employed that may eventually saturate and skew input signals over time. To compensate for this “gain drift” to re-level the signals, a time-based normalization might be desirable. In some instances, the pre-processing comprises aggregating of data. Aggregating data points over time may be desirable to reduce overall input data rate. A variety of aggregation methods, such us minimum, maximum, average, weighted average, Kalman filter, may be employed to remove noise or spikes in input signals.

A specialized computing device 160 is often chosen before configuration of data. In many instances, data and models need to be configured according to the specialized computing device 160. The specialized computing device 160 has at least one acceleration path that can execute the calculation, prediction, or classification using configured models and data. An information regarding the specialized computing device 160, including a configuration parameter regarding the acceleration path, can be obtained by the specialized computing device 160 and may be stored in a memory 165. The information may be used for configuring data and models in blocks 130 and 150. The information regarding the specialized computing device 160 comprises the configuration parameter that corresponds to a data size for which the acceleration path of the specialized computing device operates. For example, the specialized computing device 160 can be a Graphic Processing Unit (GPU) with at least one tensor core for faster matrix multiplication, and the configuration parameter may be determined to be 8, which is the required input channel number by the tensor core. The memory 165 may also be used for storing and processing data and models. The memory 165 can be a GPU memory. In some embodiments, the memory 165 can be the same memory as in blocks 115, 125, 135, or 155.

Data acquired by the data collection unit 110 or data pre-processed by the data pre-processing unit 120 are configured by a data configuration unit 130 based on the information regarding the specialized computing device 160 comprising the configuration parameter. For example, the data acquired by the data collection unit 110 may be image data with three channels, and the configuration parameter may be equal to 8. Therefore, the acquired data need to be configured by the data configuration unit 130 to have 8 channels, or to have a channel number that is a multiple of 8. In some instances, the data configuration unit 130 may be the same as the data collection unit 110 or the data pre-processing unit 120. The information regarding the specialized computing device 160 may be sent to the data configuration unit 130 through a bus 170, or alternatively, the information may be pre-acquired or determined by a general computing device and saved in a local memory 135. The configuration of data is conducted in the data configuration unit 130 according to programs in a local memory 135. In some embodiments, the local memory 135 can be the same memory as in blocks 115, 125, 155, or 165.

One or more machine learning models can be acquired by a model collection unit 140. The one or more machine learning models are trained models that can be used in a computing device. The machine learning models can be deep learning models, artificial neural network (ANN) models including convolutional neural network (CNN) models, or any other suitable models that can be used in data analysis, calculation, prediction, or classification. In some instances, the model collection unit 140 can also perform the function of model generation. Machine learning models can be generated using techniques illustrated below.

For example, a CNN model may be trained using sequencing data to predict base calls in a nucleotide sequence. The input sequencing data may be one-channel sequencing data obtained using nanopore sequencing techniques (e.g., sequencing by monitoring changes to an electrical current as nucleic acids passing through a protein nanopore, resulting in one-channel sequencing data) or using pH measurements to read nucleotide sequences (e.g., Ion Torrent sequencing), two-channel sequencing data obtained using two-channel sequencing by synthesis (SBS) technologies (e.g., Illumina's 2-Channel SBS Technology), or four-channel sequencing data using Illumina 4-channel SBS technology. In some examples, the one channel can correspond to a voltage or current. The 2 and 4 channel sequencing can use different filters to detect different colors of dyes for different nucleotides. Template nucleic acid molecules may be used so that the sequence is known.

Sequencing data of the template nucleic acid molecules can be generated using a sequencing device and used as input in training the CNN model, and the sequences of the template nucleic acid molecules are used as labels in the training. For the training purpose, the dataset of sequencing data and their corresponding sequences may be split into (i) a training set, (ii) a testing set, and/or (iii) a validation set. For certain training, more than one set of training/testing/validation sets are needed. For example, for three cycles of a training process, at least three training sets and three testing sets may be used, with each set different from another one. The disclosed methods and techniques are also suitable for data with a variety number of channels. For example, the disclosed methods and techniques can be used for configuring or training image data with three input channels.

Some features or hyperparameters of the CNN model can be predetermined. Examples of such hyperparameters are the number of convolutional layers, the number of pooling layers, the number of fully connected layers, the number of neurons in each layer, the size of the filter in each layer, the stride number, and/or the learning rate. The training set is then input into the CNN model, and the testing set is used to test the performance of the trained CNN model. If an aimed performance is not reached, a second cycle of training may be performed with a possibility of readjusting the hyperparameters of the trained CNN model.

As another example, a person's genome can be determined using other (e.g., more time-consuming) techniques to determine a reference sequence (e.g., the person's genome of a particular chromosomal region). Then, the sequence of a particular nucleic acid molecule can be determined by aligning the sequence to the reference sequence. The resulting sequences can be used as labels for supervised learning. The CNN model can then be optimized using preset criteria, where the trained CNN model can predict base calls, e.g., using one-channel, two-channel, or four-channel sequencing data or other sequencing data having some other number of channels. In some instances, a non-neural network model or an ensemble collection of models that comprise trained neural network models, may be used to perform similar functions and the disclosed methods and techniques are suitable for the non-neural network model or the ensemble collection of models.

In some instances, the model collection unit 140 may be the same as the data collection unit 110, the data pre-processing unit 120, or the data configuration unit 130. The model collection unit 140 can also perform a model selection function. In some instances, all acquired machine learning models are selected by the model collection unit 140 and sent to a model configuration unit 150 for the next-step configuration. In other instances, at least one of the acquired machine learning models are not selected by the model collection unit. The model collection step in the model collection unit 140 may be performed before the data collection step in the data collection unit 110, after the data collection step in the data collection unit 110, or simultaneously with regard to the data collection step in the data collection unit 110. The acquired or selected machine learning models can be acquired or selected automatically by a program, manually by an operation, or interactively through a user interface.

The one or more selected models are configured by the model configuration unit 150 based on information regarding the specialized computing device 160. For example, a CNN model selected by the model collection unit 140 may be suitable to predict base calls using one-channel sequencing data, while the specialized computing device 160 is a GPU with tensor cores that require the input channel to be eight. In such instance, the CNN model would need to be configured by the model configuration unit 150 to accept eight-channel input data so that the CNN model can be executed on the tensor cores of the GPU. In some instances, the model configuration unit 150 may be the same as the data collection unit 110, the data pre-processing unit 120, the data configuration unit 130, or the model collection unit 140. The information regarding the specialized computing device 160, such as in the above example where the input channel of data is required to be eight, may be sent to the model configuration unit 150 through the bus 170, or alternatively, the information may be pre-acquired or determined by a general computing device and saved in a local memory 155. The configuration of machine learning models is conducted in the model configuration unit 150 according to programs in a local memory 155. In some embodiments, the local memory 155 can be the same memory as in blocks 115, 125, 135, or 165.

The configured model(s) and data are sent to the specialized computing device 160 through the bus 170 for executing calculation, prediction, or classification. The specialized computing device 160 has at least one acceleration path that can execute the calculation, prediction, or classification using the configured model(s) and data, and the information regarding the specialized computing device 160, including the acceleration path, is used for configuring raw input data and models in blocks 130 and 150. The information regarding the specialized computing device 160 comprises a configuration parameter that corresponds to a data size for which the acceleration path of the specialized computing device operates. For example, the specialized computing device 160 can be a Graphic Processing Unit (GPU) with at least one tensor core for faster matrix multiplication, and the configuration parameter may be determined to be 8, which is the required input channel number by the tensor core. The specialized computing device 160 also has a memory 165 for storing and processing data and models. The memory 165 can be a GPU memory. In some embodiments, the memory 165 can be the same memory as in blocks 115, 125, 135, or 155.

The output of the configured model(s) using the configured data is obtained by the specialized computing device 160 with the memory 165 and sent to an output unit 180 through the bus 170. In some instances, the output unit 180 may be the same as the data collection unit 110, the data pre-processing unit 120, the data configuration unit 130, the model collection unit 140, the model configuration unit 150, or the specialized computing device 160. The output can be provided automatically by a program, manually by an operation, or interactively through a user interface.

### III. Changing Dimension of Input Data for Acceleration Path

To solve the problem that trained models and input data are not compatible with a prerequisite required to implement an acceleration path of a specialized computing device, embodiments described herein discloses methods and systems of configuring model parameters and input data to be executed on different specialized computing devices. The solution to the problem depends on the type of specialized computing devices and the type of deep learning models.

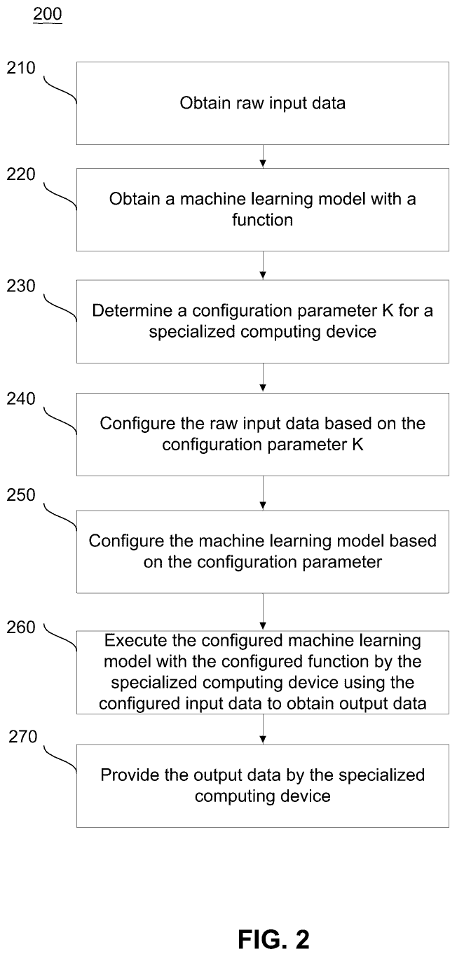

FIG. 2 shows a flow chart 200 illustrating an example method of configuring raw input data and machine learning models according to various embodiments of the present invention.

At block 210, raw input data are obtained. The raw input data may be sequencing data generated by a data generating device 105 (e.g., a sequencing device, such as a nanopore device), as shown in FIG. 1. The raw input data may also be other image data generated by an optical device. At block 210, the raw input data's set of dimensions is also obtained. The set of dimensions may include a channel dimension having a number C of channels and a first length dimension corresponding to a height or a width of the raw input data. In some instances, the set of dimensions may also include a batch number dimension having a number of N of batches.

### A. Selection of a Deep Learning Model

At block 220, a machine learning model with a function that has a set of M model parameters is obtained. The set of M model parameters can be applied to at least one channel of the raw input data. The machine learning model can be a deep learning network model. A deep learning model (deep learning network model) is usually used when a specialized computing device is needed to achieve better performance. A machine learning model other than a deep learning model may also be used in some instances. The term “machine learning model” used herein may refer to a deep learning model, and the term “deep learning model” used herein may refer to a machine learning model.

The obtaining of the machine learning model with the function may further comprise selecting one or more machine learning models from a model database, as is described in more detail below. In some instances, a deep learning model is selected. The selection of a deep learning model may be based on research or commercial needs. The deep learning model can be predetermined and acquired by the model collection unit 140 in the system 100 in FIG. 1. The selection can also be made based on a specific need and readjusted during execution or a part of the execution. In some instances, the selection may be made automatically or randomly. The selection may be adjusted interactively through a user interface. In some instances, the obtaining of the machine learning model with the function at block 220 is based on the selection. In some instances, the obtained machine learning model is a CNN model, and its function is a filter of a first layer of the CNN model.

### B. Selection of Specialized Computing Devices

The type of specialized computing devices determines the way to configure machine learning models and raw input data based on information regarding the specialized computing devices, including prerequisites regarding acceleration paths. The information is sometimes referred as a configuration parameter. For example, one GPU that has a first type of tensor cores may require an input channel size of a multiple of 8, whereas another GPU that has a second type of tensor cores may require an input channel size of a multiple 16. In the first instance, the configuration parameter is 8, and in the second instance, the configuration parameter is 16. When implementing machine learning models to be executed on the GPU with the first type of tensor cores, raw input data and the models need to be configured to have an input channel size of 8. If the configuration need is not met, the first type of tensor cores will not be fed, and the GPU will use non-acceleration cores instead to perform the model execution. In such instances, the computing efficiency is believed to be 4×-8× slower than that of tensor cores (M Andersch et al., Tensor Core DI, Performance Guide).

The selection of the specialized computing device may be based on research or commercial needs. The selection can be predetermined and set as an input or a default in the system in FIG. 1. The selection can also be made based on a specific need and readjusted during execution or a part of the execution. In some instances, the selection may be made automatically or randomly based on the inventory of hardware. The selection may be adjusted interactively through a user interface.

At block 230, a configuration parameter K for the specialized computing device is determined in parallel with the selection of the specialized computing device. The determination of the configuration parameter K may be predetermined and set as an input or a default in a system in FIG. 1, simultaneously, before, or after the selection of the specialized computing device. The determination of the configuration parameter K may be made by the same computing device that obtains the raw input data. The configuration parameter K corresponds to a data size for which an acceleration path of the specialized computing device operates. Preferably, the selection of the specialized computing device is made first in consideration of the best performance of a machine learning model, and the configuration parameter K is subsequently determined based on the selection of the specialized computing device. For example, when a GPU with tensor cores is selected as the specialized computing device, the corresponding configuration parameter K can be determined to be 8. In some instances, the order may be vice versa to avoid overwhelmed configuration regarding the selected machine learning model. The determination of the configuration parameter K may also be determined automatically or semi-automatically by the specialized computing device, or alternatively, the configuration parameter K may be determined interactively through a user interface.

### C. Preprocessing of Data and Configuration of Data

At block 240, raw input data can be directly configured based on the configuration parameter K determined at block 230. The configuration of the raw input data depends on the size and dimension of the raw input data, as well as the size and dimension of the configuration parameter K. The configuration of the raw input data includes scaling the channel dimension C by the configuration parameter K and inversely scaling the first length dimension by the configuration parameter K, thereby creating K×C channels. For example, when the GPU is selected as the specialized computing device and the corresponding configuration parameter K is determined to be 8, if the raw input data are RGB images with three channels (a red channel, a green channel, and a blue channel), the configuration of the raw input data is performed by reshaping each channel of the raw input data to 8 sub-channels (8 red sub-channels, 8 green sub-channels, and 8 blue sub-channels). Such an example can be performed for image analysis.

The reshaping may be performed by dividing data in each channel into 8 sets along the width of the raw input data. In some instances, the reshaping may be performed by dividing data in each channel into 8 sets along the height of the raw input data. In some instances, the reshaping may be performed by dividing data in each channel into 8 sets along a dimension other than the width and height of the raw input data. In some embodiments, the preprocessing and the configuration of data mat be based on a dimension other than the channel dimension. A same or substantially similar method can be performed based on any dimension of the raw input data. For the convenience of expression, the dimension where the configuration applies is referred as the “channel” or “channel dimension.”

The configuration of the raw input data is not necessarily strictly followed in that the number of sub-channels equals the value of the configuration parameter K. In some instances, the raw input data are configured to subsets of data and the number of the subsets equals a multiple of the value of the configuration parameter K. For example, when K equals 8, the configuration of the raw input data may be performed by reshaping each channel of the raw input data to 16, 24, 32, or any multiple of 8 sub-channels.

Sometimes the raw input data are pre-processed before block 240. Sometimes the pre-processing of the raw input data is part of the configuration at block 240. The pre-processing of the raw input data depends on their size and quality. For example, if the raw input data are a batch of images of different sizes, the pre-processing may resize the batch into the same size. The uniformed size may be predetermined, or determined based on the configuration parameter K. For example, if the number of pixels on the dimension to be reshaped is not a multiplication of the value of the configuration parameter K, additional pixels with value 0 may be padded to the raw input data to expand the number of pixels on the dimension to be reshaped a multiple of 8. Other suitable methods may also be used to pre-process the raw input data.

### D. Configuration of Deep Learning Models

At block 250, the obtained machine learning model with the function is configured at based on the configuration parameter K. The configuration of the model depends on the type of the model. The configuration includes expanding the function to include at least K×M model parameters that are applied to at least K channels. The configuration of the model can be a configuration of model parameters. In some instances, the configuration of the model can be a configuration of a subset of model parameters. For example, when the obtained machine learning model is a CNN model with filters for different convolutional layers, the configuration of the CNN model can be a configuration of the filter for the first convolutional layers. In some instances, the disclosed techniques and methods can be applied to the configuration of the deep learning model regarding a filter for an intermediate layer (e.g., any layer between the input layer and the output layer) or an output layer of the model.

The configuration of a filter may include expanding the filter. If the original filter has M model parameters, the expanded filter then has at least K×M parameters. The expanded filter can be applied to the at least K channels. In some instances, the configuration of a filter includes expanding the filter to a sparse filter. In one dimension of the sparse filter, each entry of the diagonal in the dimension corresponds to the original filter, and all other entries have a value of zero (e.g., a Toeplitz matrix).

### E. Execution of Configured Models and Data

At block 260, the configured machine learning model by block 250 and the configured raw data by block 240 are sent to and executed by the specialized computing device to perform calculations, classifications, and predictions. Because of the configurations taking place at blocks 240 and 250, the calculations, classifications, and predictions are able to utilize the acceleration path of the specialized computing device, and calculations, classifications, and predictions are performed much more computationally efficiently than those performed on a general computing device, or a non-acceleration path of a specialized computing device. In some instances, the calculations, classifications, and predictions performed on the acceleration path of the specialized computing device improve the energy efficiency as well.

### F. Outputs, Iterations, and Rectifications

At block 270, the output is provided by the specialized computing device. The output of a deep learning model can take many different forms and may be used for the next step of processing, predicting, or diagnosis. In some instances, the configuration at block 240 and block 250 may be iterated based on the research or commercial needs or based on the type of the machine learning model. For example, when the machine learning model is a ResNet model, a second round of configuration of the ResNet model may be conducted to configure filters in a second convolutional layer or a skipped layer. Although a ResNet model may have a multiple of 8 number of filters in the first convolutional layer, when the number of filters in the first convolutional layer of the ResNet model is not a multiple of 8, a configuration of the model regarding its second convolutional layer may be performed. In some instances, the configuration may be readjusted interactively by a user interface to achieve optimal performance. In some instances, the output may be rectified by a user of the user interface.

Other techniques to the configuration include adding an addition layer of convolution with required input and output channels, copying the input data to a padded buffer, and/or retraining the model with required input channels. These methods can be combined with the techniques described above and apply in different circumstances.

### IV. Example Configuring of Data and Models

Examples below illustrate how data can be generated, collected, and configured and how CNN models are configured based on the requirements of tensor cores of a GPU according to various embodiments of the present invention. The examples also illustrate data and model configuration in an exemplary physical environment. It should be understood that the examples described herein do not mean to be exclusive and any suitable methods and systems may be used and performed the same function as the examples.

### A. 8-Channel Convolution for Graphics Processing Units

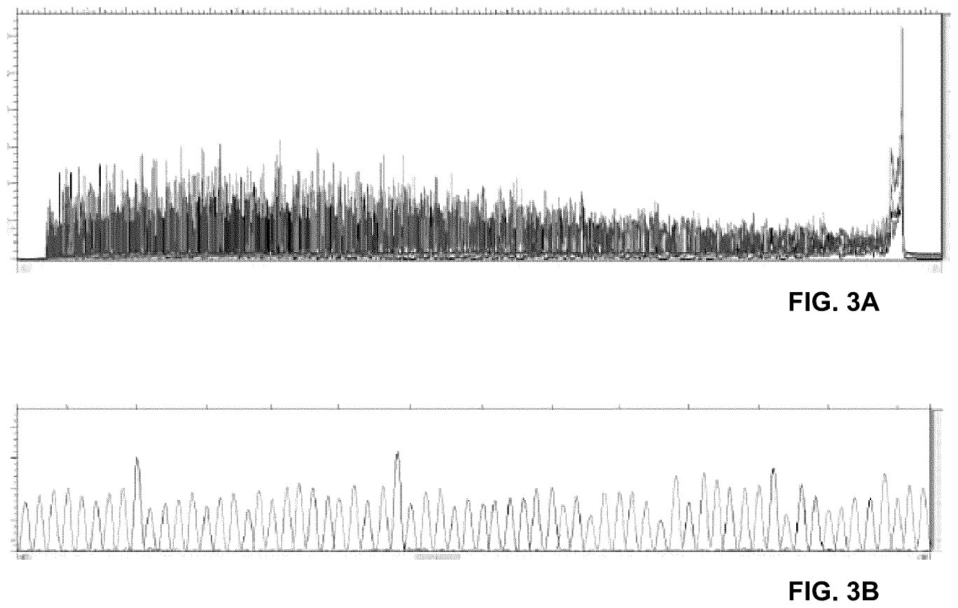

FIGS. 3-11 illustrate examples of configuring data and CNN models to be executed by GPUs that require input data and models to have the number of channels be a multiple of 8 to be executed on their acceleration path (“8-channel GPUs”) and the execution of the configured model using the configured data, as discussed in the flowchart in FIG. 2.

### 1. Obtained Raw Input Data and Filters of CNN Models

A first step can obtain raw input data (e.g., block 210 in FIG. 2) and CNN models (e.g., block 220 in FIG. 2) to be executed by the 8-channel GPUs. The raw input data and CNN models can be of various sizes and dimensions. The obtained raw input data may be pre-processed (e.g., by the data pre-processing unit 120 of the system 100 in FIG. 1) before configuration. For example, when the raw input data are image data of different sizes, they may need to be chopped and resized to have a same size in their every dimension to be configured as a batch. There might be other instances that the raw input data need to be pre-processed. The CNN models are obtained with information regarding their filters (e.g., a function at block 220). For each CNN model, there should be at least one filter in each layer of the CNN model, and there should be more than one layer in the CNN model. The filters are matrices of various size and dimensions. Because the dimensions of the filters do not always satisfy the requirement of the 8-channel GPUs, the filters need also be configured before the execution by the 8-channel GPUs.

FIG. 3A illustrates exemplary raw sequencing data obtained at block 210 in FIG. 2. As can be seen from the figure, the raw sequencing data may be fluorescence signals that are generated by fluorescently dying nucleic acid materials of a sample and have an input channel of one, two, or four. In such instance, the raw input data may be hard or impractical to be processed by a machine learning model and a pre-processing process as discussed in the data pre-processing unit 120 in FIG. 1 may be performed.

FIG. 3B shows the pre-processed sequencing data. As examples, the pre-processing of the colored sequencing data may include denoising, color separation, baseline correction, and/or mobility shift correction. The criteria of these pre-processing functions may be preset, with an aim to preserve unbiased information as those contained in the raw input data. In some instances, the pre-processed sequencing data will replace the original obtained raw sequencing data and be configured and analyzed in a later step.

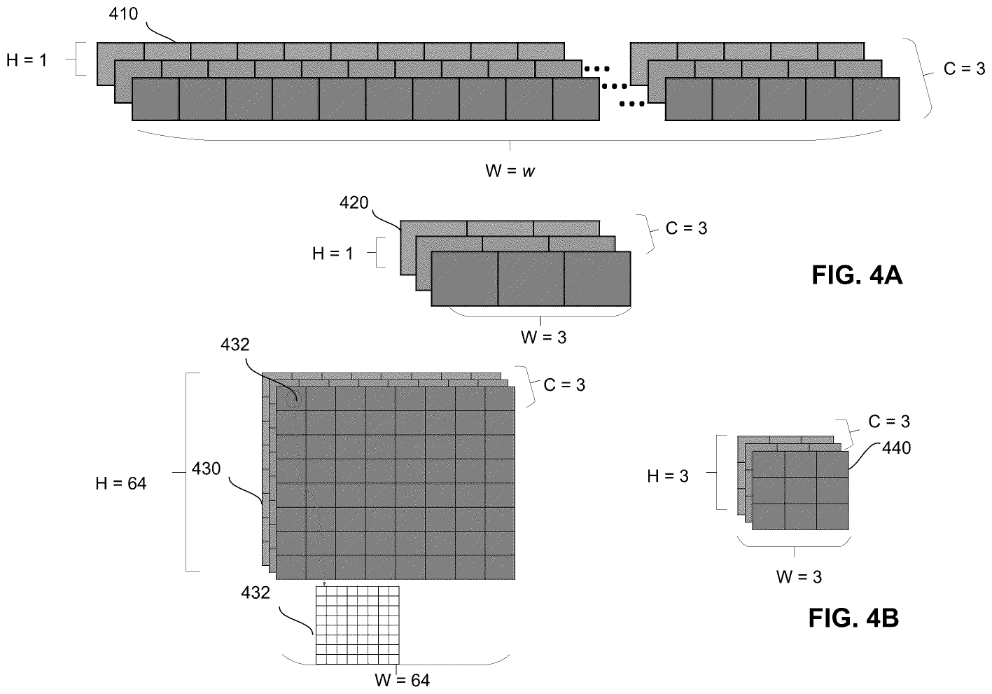

FIGS. 4A and 4B illustrates visualized examples of the raw input data and filters of the CNN models. The raw input data obtained at block 210 in FIG. 2 can be in the NHWC format with N standing for a number of the raw input data in a batch (e.g., a batch of N images), H for a height of a raw input datum, W for a width of the raw input datum, and C for a number of channels of the raw input datum. For example, the raw input data have dimensions of n-by-h-by-w-by-c. The height of the raw input datum can be the vertical dimension of the raw input datum and the width of the raw input datum can be the horizontal dimension. In some instances, H, W, and C dimensions can be switched. For example, the height of the raw input datum can be the horizontal dimension of the raw input datum and the width of the raw input datum can be the vertical dimension. One exemplary CNN model is a machine learning model with a function with M model parameters. The function and the value of M may be dependent on a filter of the CNN model. Examples of the raw input data include images, sequences (e.g., nucleic acid sequences), or signals generated during a sequencing process.

FIG. 4A illustrates sample raw image data 410 with a filter 420 of a CNN model. The raw image data 410 can be generated by the data generating device 105, such as a photonic sensing device. Images captured by the data generating device 105 may be pre-processed and converted to the raw sequencing data 410. In some instances, the raw image data 410 may be sequencing data based on fluorescence signals generated by a fluorescent microscopy sequencing device. The raw image data 410 may also be sequencing data generated by a nanopore-based sequencing device. The sequencing data may be data having a channel number different than that shown in FIG. 4A. For example, the sequencing data may have one, two, or four channels. The techniques, methods, systems, and examples disclosed herein are suitable for and can be applied to data with different dimensions. For the convenience of expression, the examples discussed herein use data with three channels.

As shown in FIG. 4A, the raw image data 410 may be RGB image data. In this instance, the input channel number of the raw image data 410 is 3. As discussed above, the input channel number may be different than 3, for example, the input channel number may be 1, 2, or 4. Each cell of the raw image data 410 may represent one pixel of the image data. The NHWC format of this raw image data 410, as shown in FIG. 4A, is 1-by-1-by-w-by-3, where w is determined by the obtained image width. The height of the raw image data 410 is shown to be 1, and the height may be a number other than 1. When the height is 1, the number of dimensions can be identified 2 (the width dimension and the channel dimension). When the height is not 1, the number of dimensions can be identified 3 (the height, width, and the channel dimensions).

In the example in FIG. 4A, the filter 420 has a size of 1×3×3. Each channel of the filter 420 is suitable for determining a specific character of the same channel of the image data 410. For example, the red channel of the filter f 420 may be used to determine the probability of a signal to be red. The size of the filter f 420 may vary based on the need of classification. When omitting the channel dimension, commonly used filter size is 1×3, 1×5, and 1×7 for sequencing data. The number of dimensions of the filter is not always suitable to be executed by a specialize computing device using its acceleration path to achieve computational efficiency. In this example, the filter 420 has three channels, while a GPU with tensor cores may require an input channel number to be 8 to use its acceleration path. In this instance, the filter 420, or the corresponding CNN model need to be configured to have a channel number of 8, or a multiple of 8.

FIG. 4B illustrates three-dimensional raw input data 430 with a filter 440 of a CNN model. The raw input data 430 of FIG. 4B may illustrate a three-dimensional image with three channels (RGB). Cell 432 is one cell on the red channel of the raw input data 430. In some instances, each cell can represent more than one pixel of the image. For example, the cell 432 in each channel of the raw input data 430 may represent 64 pixels (8-by-8), as shown in FIG. 4B. In such an instance, the H, W, and C dimensions of the raw input data 430 are 64-by-64-by-3. The number 64 is only for an illustration purpose. The actual size or pixel number of the raw input data can vary based on research or commercial needs. The HW dimensions of the raw input data 430 can square, or non-square rectangular.

As shown in FIG. 4B, the HWC dimension of the filter f 440 is 3-by-3-by-3. The HW dimension of the filter 440 can also be either square or non-square rectangular. When omitting the channel dimension, commonly used filter size is 3×3, 5×5, and 7×7 for three-dimensional image data. Each channel of the filter f 440 may be suitable for determining a specific character of the same channel. For example, the red channel of the filter f 440 may be used to detect the horizontal or vertical boundary of a specific character on the red channel. The filter f 440, as shown in the example, can be also seen as a function of the CNN model with 27 model parameters (3×3×3). As discussed in FIG. 4A, the number of dimensions of a filter 440 is not always suitable to be executed by a specialize computing device using its acceleration path to achieve computational efficiency.

### 2. Executing Raw Input Data on CNN Filters

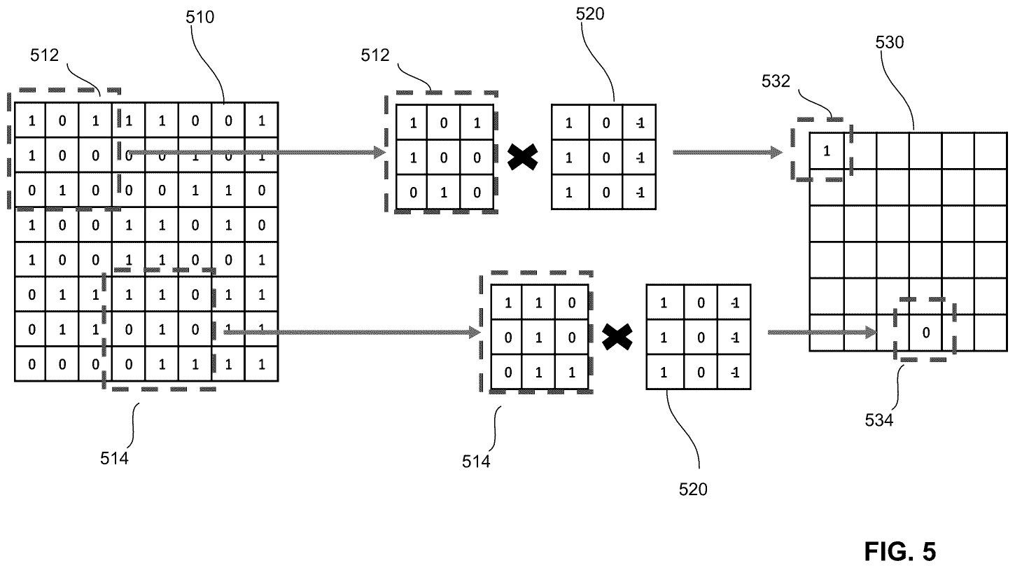

FIG. 5 illustrates an example of performing convolution on the raw input data using a channel of a filter in a convolutional layer of the CNN model. Matrix 510 may represent the red channel of the cell 432 in FIG. 4B, and matrix 520 may represent the red channel of the filter 440. Here the matrix 520 may perform a function of detecting the vertical boundary on the red channel. Because the size of the matrix 520 is 3×3, a submatrix of the matrix 510 having a size 3×3 will be multiplied by the matrix 520. For example, a cell 532 in a result matrix 532 may be obtained by multiplying a submatrix 512 with the matrix 520, and a cell 534 in the result matrix 532 may be obtained by multiplying a submatrix 514 with the matrix 520. The matrix multiplication performed here is a dot-multiplication, which the cell in the same column and the same row of each matrix is multiplied and the multiplications of cells are added together to get the result.

It could be seen from FIG. 5 that generally for each channel of raw input data, there is a corresponding channel of a filter in a CNN model to detect a specific character of the raw input data on the channel. When implementing the next step of configuring data and models, the same consideration should be made that the configuration of data requires a configuration of models. In some instances, more than one channel of the filter may correspond to specific characters of the raw input data on the channel. In some instances, the three-channel filter applies to the three-channel raw input data as a whole and the result data has one channel. In some instances, more than one filter is applied in a convolutional layer of a CNN model, and the result data from each filter-application.

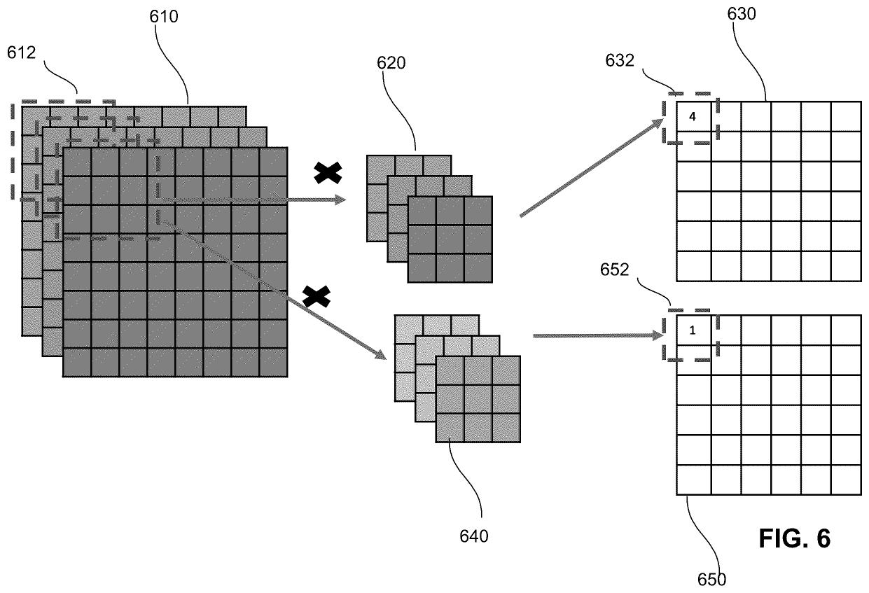

FIG. 6 illustrates an example of performing convolution on the raw input data using multiple filters in a convolutional layer of the CNN model. Raw input data 610 have three channels and filters 620 and 640 are two different filters of same dimensions (3×3×3). In this example, each filter applies to the raw input data 610 as a whole, and each filter-application results in a one-channel result data, as shown in result data 630 and 640. In such an instance, a submatrix 612 is multiplied by the filter 620 (and the filter 640), and a single value is obtained and recorded to a cell 632 (and a cell 652) in the result data 630 (and the result data 640). The result data 630 and 640 may be combined later and be two channels of combined result data to be performed by the CNN model in later layers.

Examples in FIGS. 5 and 6 illustrate that, in most instances, the channel number in each filter is the same as the channel number in the data to be executed by the CNN model. It means that CNN models are generally specifically trained for a specific input channel data and thus filters in the CNN models have a matched number of channels. When raw input data have an unmatched number of channels, either they cannot be executed by the CNN models, or the CNN models have to be configurated to have a matched number of channels as what the raw input data have.

### 3. Configurations of Data and Models

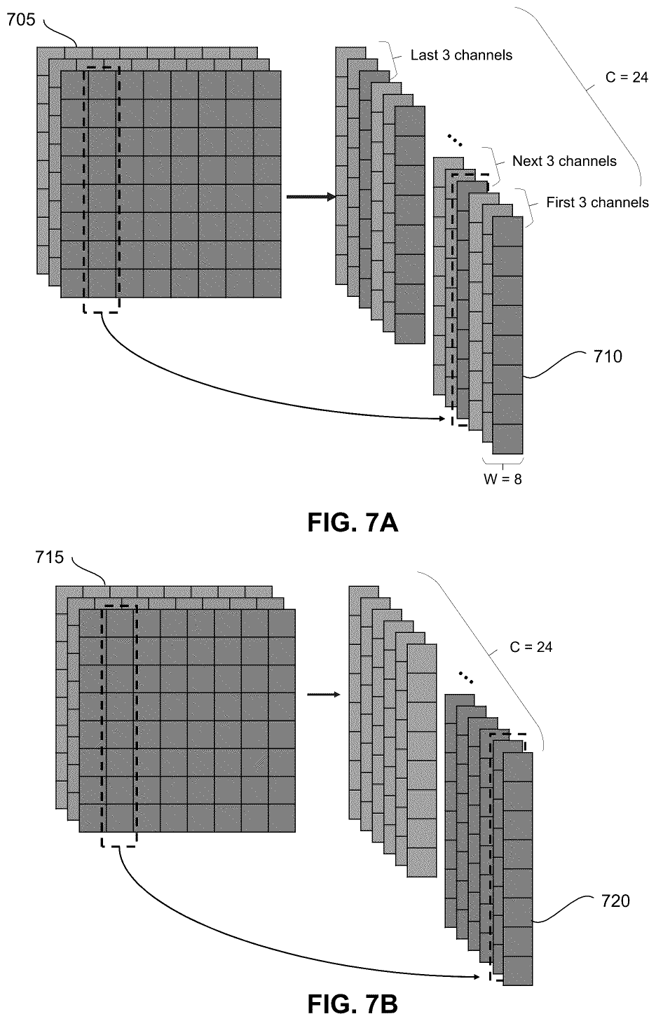

Executing CNN models on a general computing device can be time consuming. Therefore, a trend in the industry and research is to use specialized computing device to execute CNN models. In many embodiments, the specialized computing device is a GPU. The specialized computing device in this example is a GPU with tensor cores that require the input channel number to be 8. It means executing standard three-channel RGB data on CNN models trained for three-channel input data will not take advantage of the fast-computing speed of the specialized computing device. To achieve time and computing efficiency, both raw input data and corresponding CNN models need to be configured based on a configuration parameter k. In such an instance, the configuration parameter k of the specialized computing device is determined to be 8, corresponding to block 230 in FIG. 2. The configuration parameter k=8 is going to be used in the following steps for configuration of the raw input data and the CNN models. For the illustration purpose, the examples shown in FIGS. 7A and 7B only demonstrate the configuration corresponding to the three-dimensional raw input data 430, as shown in FIG. 4B.

FIG. 7A illustrates an exemplary visualization of configuring three-dimensional raw input data 705 (the raw input data 430 as shown in FIG. 4B) to be suitable for executing on the 8-channel GPU. After obtaining the raw input data of size n-by-h-by-w-by-c (here 1-by-64-by-64-by-3) as shown in FIG. 4B, the raw input data can be configured to a size of n-by-h-by-w/k-by-ck (here 1-by-64-by-8-by-24), as shown in the configured input data 710 of FIG. 7A.

In some instances, the configuration of the raw input data (shown at block 240 of FIG. 2) is done by reshaping the raw input data 705. For example, the first 8 pixels in each row of the raw input data 705 are preserved in the first three channels, and the next 8 pixels in each row of the raw input data 705 are sent to the next three channels (exemplarily shown in the dot box in FIG. 7A), and so on. The configuration by the reshaping guarantees that the configured input data has a channel number equal to a multiple of the configuration parameter, which is 8 in this example. After configuration, the channel number of the configured input data 710 is 24, which is a multiple of 8. Thus, the input data are configured to be able to utilize the acceleration path of the GPU. In some instances, each three channels are treated by the GPU as a whole and the configured input data has a new channel number to be 8.

FIG. 7B illustrates another exemplary visualization of configuring three-dimensional raw input data 715 (the raw input data 430 as shown in FIG. 4B) to be suitable for executing on the 8-channel GPU. After obtaining the raw input data of size n-by-h-by-w-by-c (here 1-by-64-by-64-by-3) as shown in FIG. 4B, each channel of the raw input data can be configured to a size of n-by-h-by-w/k (here 1-by-64-by-8), as shown in the configured input data 720 of FIG. 7B.

In the example in FIG. 7B, the first 8 pixels in each row of the red channel of the raw input data 715 are preserved in the first channel, and the next 8 pixels in each row of the raw input data 715 are sent to the next channel (shown in the dot box in FIG. 7B), and so on. The configuration by the reshaping guarantees that the configured input data has a channel number equal to a multiple of the configuration parameter, which is 8 in this example. After configuration, the channel number of the configured input data 720 is 24 (first eight channels correspond to the red channel in the raw input data 715, and so on), which is a multiple of 8. Thus, the input data are configured to be able to utilize the acceleration path of the GPU. In some instances, each eight channels are treated by the GPU as a batch and each batch of the configured input data has a new channel number to be 8.

In some instances, the configuration of the raw input data comprises an overlapped reshaping of data, that is, the configuration of the raw input data comprises padding. For example, when concerning information may be lost during reshaping, a channel of the configured input data may share same information in different channel of the configured data. For example, information in the last two columns of the first channel of the configured input data may be the same as information in the first two columns of the fourth channel of the configured input data. The size or repetition of the overlapped information depends on various factors, e.g., the size of the filter, information sensitivity, and performance of the trained CNN model.

There are at least two padding modes to process the configured data that can be used regarding the execution of configured models on the configured data. One commonly used mode is the VALID padding, which does not require to perform extra padding on the configured data and assumes that the configured data can be fully covered by the configured filter. Another commonly used mode is the SAME padding, which required the size of the input data equals to the size of the output data. In such instances, the configured input data is padded according to the size of the configured filter and all padded values equal to zero.

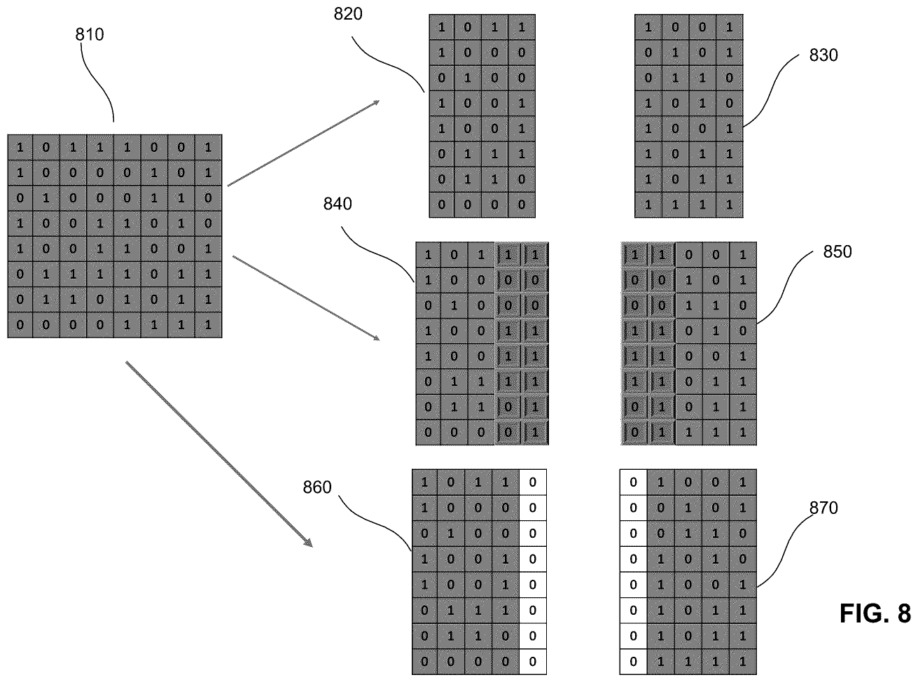

FIG. 8 illustrates three examples of configuring raw input data according to various embodiments. Matrix 810 represents a red channel of exemplary raw input data. When the raw input data doubles its original channel number based on the configuration parameter, each channel of the raw input data can be configured to two new channels. A first way is to do a separation, in which a padding is not performed, as shown in matrices 820 and 830. The first four columns of the matrix 810 are used to form the matrix 820, and the last four columns of the matrix 810 are used to form the matrix 830. A second way allows overlapping segments, which uses partial raw input data to perform a padding, as shown in matrices 840 and 850. The first five columns of the matrix 810 are used to form the matrix 840, and the last five columns of the matrix 810 are used to form the matrix 850. In such an instance, both the matrices 840 and 850 share the information in the fourth and fifth columns of the matrix 810, that is, the matrices 840 and 850 overlap. The size of the overlapped information may vary. A third way to configure the raw input data is to perform padding using zero values, as shown in matrices 860 and 870. To preserve information on an edge of the matrices 860 and 870, a pad column with values equal to 0 is added to both the matrices 860 and 870. In some instances, more than one pad column may be added, and the values may be different than 0. It should be understood that the three ways are illustrative, not exclusive. Different configuration methods may be used.

As discussed above, when the channel number of configured input data does not match the channel number of filters in a trained CNN model, the CNN model may be configured. The configuration of CNN models at block 250 in FIG. 2 can be done by configuring filters. The filters can be configured by replication and/or readjustment including resizing. For example, when raw input data are configured to have a channel number of 24, a filter of size 3-by-3-by-3 in the corresponding CNN model can be configured by replicating the three-channel filter to each three channels of a 24-channel filter which has a size of 3-by-3-by-24. In such instance, there is a corresponding channel of the configured filer so that executing the CNN model using the configured model is feasible.

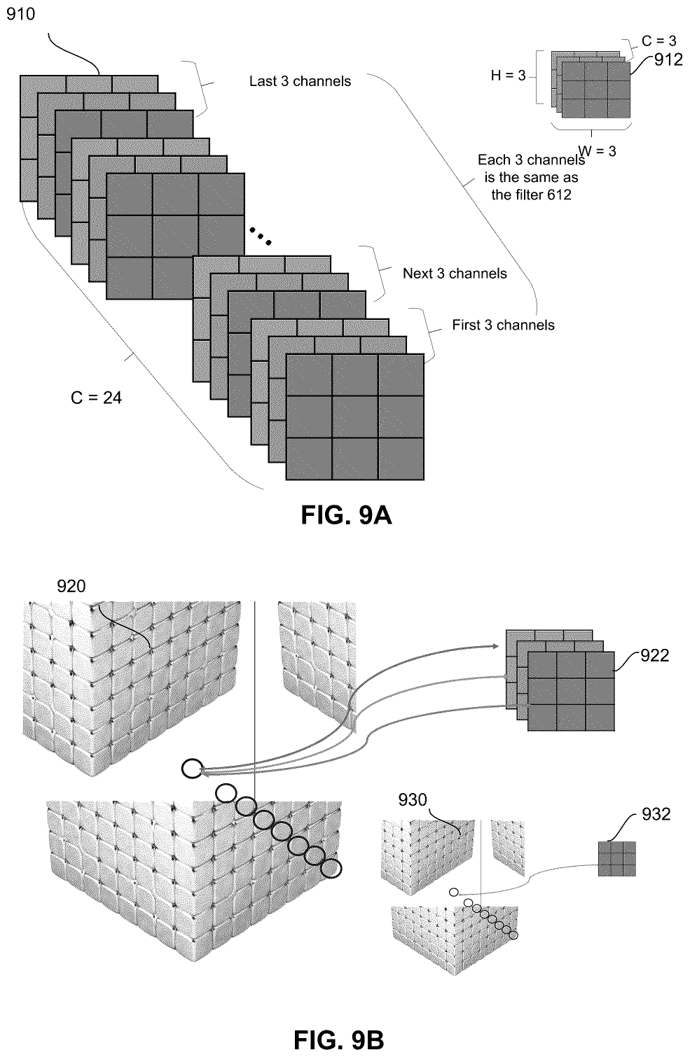

FIGS. 9A and 9B illustrate two exemplary ways of configuring a filter 912 in a CNN model to be executed on an 8-channel GPU using configured input data. A first way to configure the filter 912 is by replicating the filter 912 in each three new channels. As shown in FIG. 9A, it is possible to configure a replica filter 910, which replicates the filter 912 in each three channels. That is, the first three channels of the replica filter 910, the next three (4th to 6th) channels of the replica filter 910, . . . and the last three (22nd to 24th) channels of the replica filter 910 are all the same as the filter 912. The replica filter 910 may be used when CNN models are set to execute dot multiplication on each channel of filters, instead of execute dot multiplication on each filter as a whole (e.g., when executing dot multiplication on each channel of filters, the resulting internal data have the same number of channels as the filters; in contrast, when executing dot multiplication on each filter as a whole, the resulting internal data have one channel corresponding to each filter).

FIG. 9B illustrates a second way to configure the filter. In this configuration, a sparse filter that copies the filter in some of its cells is generated. As shown in FIG. 9B, there are two ways to generate a sparse filter. The first way is to consider a three-channel filter 922 as a whole and configure it to a sparse filter 920 that replicates the filter 922 in a diagonal direction, as shown by the circles on the sparse filter 920. The two dimensions where the diagonal locates are of the same number, and the number is generally equal to the configuration parameter (here it is 8). The third dimension of the sparse filter 920 equals the number of filters in the layer where the configuration is performed. For example, if the configuration is performed in the first convolutional layer of a CNN model, and there are eight filters to extract features from raw input data, then the third dimension of the sparse filter 920 is eight, as shown in FIG. 9B. As a general setting of a CNN model, the third dimension may be a multiple of 8.

A second way to configure a filter is to configure the filter by each channel to a sparse filter 930 that replicates a channel 932 of the filter in a diagonal direction, as shown by the circles on the sparse filter 930. For example, the channel 932 represent a red channel of the filter 922. In this sparse filter 930, the two dimensions where the diagonal locates are also of the same number, and the number is generally equal to the configuration parameter (here it is 8). The third dimension of the sparse filter 930 equals the number of filters in the layer where the configuration is performed. For example, if the configuration is performed in the first convolutional layer of a CNN model, and there are eight filters to extract features from raw input data, then the third dimension of the sparse filter 920 is eight. As a general setting of a CNN model, the third dimension may be a multiple of 8. There may be three different sparse filters in this instance, one for each channel.

The second way to configure filters are suitable for almost all instances, especially when CNN models are set to execute dot multiplication on each filter as a whole, instead of execute dot multiplication on each channel of a filter. It provides at least 3× computational efficiency in execution on an 8-channel GPU. An exemplary code is shown below.

pad_size = k
filterValNew = np.zeros([pad_size, num_channels_out,

pad_size, num_channels_in,
filter_height,filter_width]

for i in range(0, pad_size):
filterValNew[i, :, i,:, :, :] = filterVal
num_channels_out_padded = pad_size * num_channels_out
biasValNew = np.tile(biasVal, pad_size)

When performing the matrix multiplication by the GPU tensor cores that require 8-channel inputs, the calculation using the configured input data and the sparse filter by the processes described above performs at least 3× faster than the calculation using the raw input image and the original filter f. It should be understood that the two ways are not exclusive in conducting the configuration of filters. Similar methods may be used to perform the configuration of the CNN models or the filters.

### 4. Execution of Configured Models on Configured Data

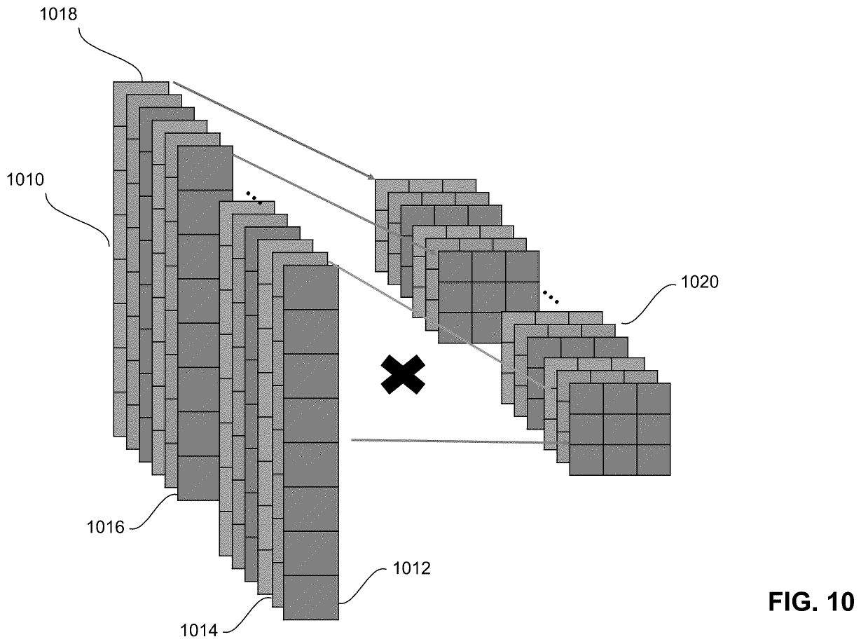

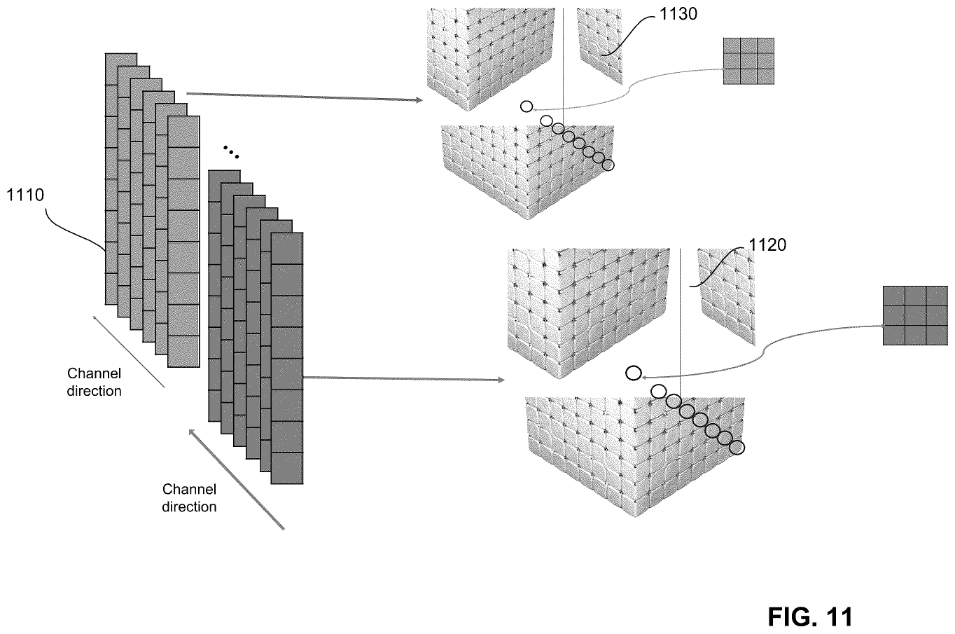

FIGS. 10 and 11 show the execution of the configured models on the configured data. More specifically, FIG. 10 shows an execution using configured data 1010 (configured as shown in FIG. 7A) and configured models that have filters configured by replication, as shown in FIG. 9A. FIG. 11 shows an execution using configured data 1110 (configured as shown in FIG. 7B) and configured models that have sparse filters, as shown in FIG. 9B.

In FIG. 10, the configured data 1010 has replicated channels, for example, a first red channel 1012, a first green channel 1014 (which is also the second channel of the configured data 1010), an mth red channel 1016, and an nth blue channel 1018 (also the last channel of the configured data 1010). A corresponding configured filter 1020 is filter formed by replication, and the configured filter 1020 has the same number of channels as that of the configured data 1010. To execute the corresponding CNN model using the configured data 1010, a dot multiplication is performed on each channel of the configured data 1010 with the corresponding channel of the configured filter 1020. For example, the first red channel 1012 is dot-multiplied with the first red channel of the configured filter 1020. The resulting internal data will have a same number of channels as that of the configured data 1010 (as well as the configured filter 1020).

In FIG. 11, the configured data 1110 has replicated channels in groups, for example, the first several channels are red channels, and the last several channels are green channels. Different configured filters may be used in this instance. A configured filter 1120 is a filter to help red channels of the configured data 1110 to be executed by a corresponding CNN model, and a configured filter 1130 is a filter to help blue channels of the configured data 1110 to be executed by the corresponding CNN model. When executing the corresponding CNN model using the configured data 1110, a dot multiplication is performed along the channel direction (marked in FIG. 11) of the configured data 1110 with the corresponding configured filters 1120 and 1130.

### B. Sample System to Perform the Processes

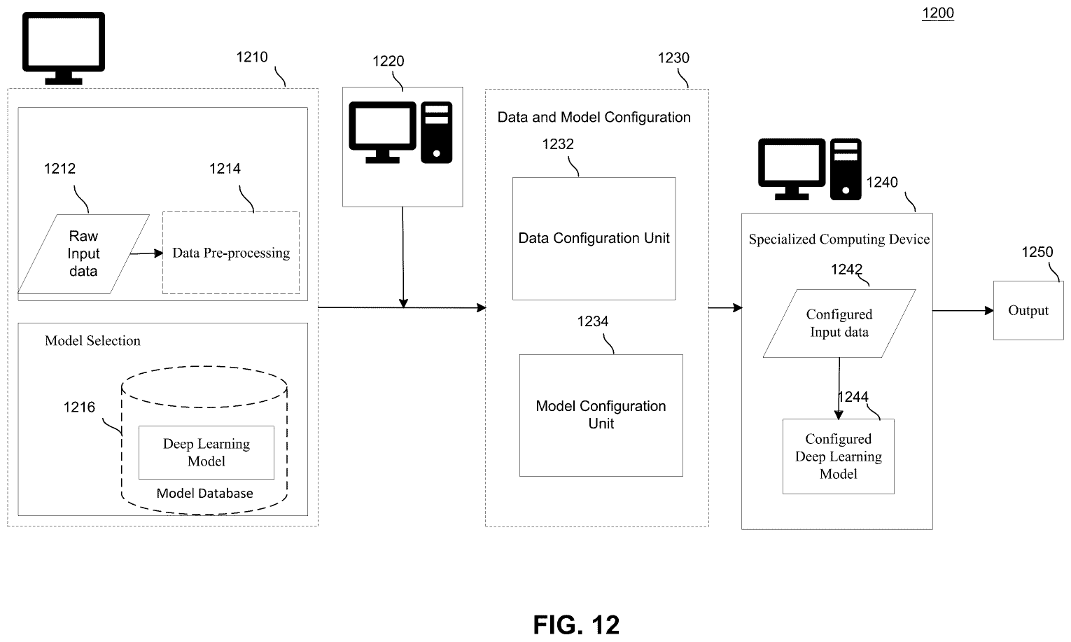

FIG. 12 illustrates an example of physical computing environment 1200 according to certain embodiments of the present invention. System 1210 is a data and model preparing system where raw input data are acquired in module 1212 and may be preprocessed by data pre-processing module 1214, and models may be selected from a model database 1216. The raw input data maybe sequencing data such as sequencing impulse data, or the raw input data may be three-dimensional image data. The raw input data in module 1212 can be generated by the data generating device 105 in FIG. 1, or obtained by the data collection unit 110. Module 1214 may correspond to the data pre-processing unit 120 in FIG. 1. The pre-processing may include denoising, color separation, baseline correction, mobility shift correction, resizing, reshaping, and the like.

The model database 1216 may include only CNN models, only ANN models, or a combination of different types of deep learning or ML models. The model selection function in system 1210 may be performed by the model collection unit 140 in FIG. 1. The system 1210 can be implemented on a general computing device. In some instances, the system 1210 can be also implemented on a specialized computing device.

Module 1220 is a specialized computing device information-acquiring module. The module 1220 acquires information regarding the acceleration path of the specialized computing device. For example, when the specialized computing device is a GPU, the information may be the type of tensor cores used by the GPU and the prerequisite of using the tensor cores. The information may also include a configuration parameter, which is the required input channel number by the tensor cores. For example, the tensor cores of the GPU may require the input to have 8 channels. In such instance, the configuration parameter is 8. Module 1220 can perform the function at block 230 in FIG. 2. The module 1220 may be an external module to the system 1210. In some instances, the module 1220 may be an internal module of the system 1210.

System 1230 is a data and model configuration system where data are configured in a data configuration unit 1232 and models are configured in a model configuration unit 1234. The data configuration unit 1232 performs the same or similar function required at block 240 in FIG. 2, and the model configuration unit 1234 performs the same or similar function required at block 250. Exemplary data configuration and model configuration processes can be found in FIGS. 7A-7B and 9A-9B. The system 1230 may be implemented on a general computing device. In some instances, the system 1230 can be also implemented on a specialized computing device. The system 1230 can be implemented on the same specialized computing device as the system 1210 is implemented. In certain instances, the system 1230 may be partially implemented on a general computing device and partially on a specialized computing device. For example, the data configuration unit 1232 is implemented on a general computing device and the model configuration unit 1234 is implemented on a specialized computing device.

System 1240 is an execution system that is implemented on a specialized computing device. Configured input data are acquired by a module 1242 and sent to module 1244 where the configured deep learning model is acquired for execution. The execution takes place on the acceleration path of the specialized computing device. In the instances where the specialized computing device is a GPU, the acceleration path is tensor cores, and the execution may achieve both computational efficiency and energy efficiency. Output of the execution may be provided by an output module 1250. The output module 1250 can be an internal module of the system 1240. In some instances, the systems 1210, 1230, and 1240 are implemented on the same specialized computing device.

### V. Computer System

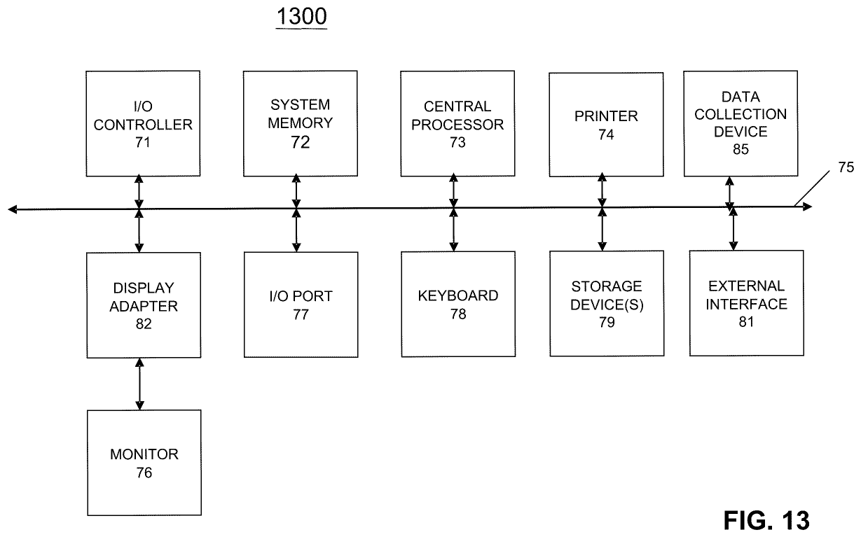

Any of the computer systems mentioned herein may utilize any suitable number of subsystems. Examples of such subsystems are shown in FIG. 13 in computer system 1300. In some embodiments, a computer system includes a single computer apparatus, where the subsystems can be the components of the computer apparatus. In other embodiments, a computer system can include multiple computer apparatuses, each being a subsystem, with internal components. A computer system can include desktop and laptop computers, tablets, mobile phones and other mobile devices.

The subsystems shown in FIG. 13 are interconnected via a system bus 75. Additional subsystems such as a printer 74, keyboard 78, storage device(s) 79, monitor 76, which is coupled to display adapter 82, and others are shown. Peripherals and input/output (I/O) devices, which couple to I/O controller 71, can be connected to the computer system by any number of means known in the art such as input/output (I/O) port 77 (e.g., USB, FireWire®). For example, I/O port 77 or external interface 81 (e.g. Ethernet, Wi-Fi, etc.) can be used to connect computer system 10 to a wide area network such as the Internet, a mouse input device, or a scanner. The interconnection via system bus 75 allows the central processor 73 to communicate with each subsystem and to control the execution of a plurality of instructions from system memory 72 or the storage device(s) 79 (e.g., a fixed disk, such as a hard drive, or optical disk), as well as the exchange of information between subsystems. The system memory 72 and/or the storage device(s) 79 may embody a computer readable medium. Another subsystem is a data collection device 85, such as a camera, microphone, accelerometer, and the like. Any of the data mentioned herein can be output from one component to another component and can be output to the user.

A computer system can include a plurality of the same components or subsystems, e.g., connected together by external interface 81, by an internal interface, or via removable storage devices that can be connected and removed from one component to another component. In some embodiments, computer systems, subsystem, or apparatuses can communicate over a network. In such instances, one computer can be considered a client and another computer a server, where each can be part of a same computer system. A client and a server can each include multiple systems, subsystems, or components.

Aspects of embodiments can be implemented in the form of control logic using hardware (e.g. an application specific integrated circuit or field programmable gate array) and/or using computer software with a generally programmable processor in a modular or integrated manner. As used herein, a processor includes a single-core processor, multi-core processor on a same integrated chip, or multiple processing units on a single circuit board or networked. Based on the disclosure and teachings provided herein, a person of ordinary skill in the art will know and appreciate other ways and/or methods to implement embodiments of the present invention using hardware and a combination of hardware and software.

Any of the software components or functions described in this application may be implemented as software code to be executed by a processor using any suitable computer language such as, for example, Java, C, C++, C#, Objective-C, Swift, or scripting language such as Perl or Python using, for example, conventional or object-oriented techniques. The software code may be stored as a series of instructions or commands on a computer readable medium for storage and/or transmission. A suitable non-transitory computer readable medium can include random access memory (RAM), a read only memory (ROM), a magnetic medium such as a hard-drive or a floppy disk, or an optical medium such as a compact disk (CD) or DVD (digital versatile disk), flash memory, and the like. The computer readable medium may be any combination of such storage or transmission devices.

Such programs may also be encoded and transmitted using carrier signals adapted for transmission via wired, optical, and/or wireless networks conforming to a variety of protocols, including the Internet. As such, a computer readable medium may be created using a data signal encoded with such programs. Computer readable media encoded with the program code may be packaged with a compatible device or provided separately from other devices (e.g., via Internet download). Any such computer readable medium may reside on or within a single computer product (e.g. a hard drive, a CD, or an entire computer system), and may be present on or within different computer products within a system or network. A computer system may include a monitor, printer, or other suitable display for providing any of the results mentioned herein to a user.

Any of the methods described herein may be totally or partially performed with a computer system including one or more processors, which can be configured to perform the steps. Thus, embodiments can be directed to computer systems configured to perform the steps of any of the methods described herein, potentially with different components performing a respective steps or a respective group of steps. Although presented as numbered steps, steps of methods herein can be performed at a same time or in a different order. Additionally, portions of these steps may be used with portions of other steps from other methods. Also, all or portions of a step may be optional. Additionally, any of the steps of any of the methods can be performed with modules, units, circuits, or other means for performing these steps.

The specific details of particular embodiments may be combined in any suitable manner without departing from the spirit and scope of embodiments of the invention. However, other embodiments of the invention may be directed to specific embodiments relating to each individual aspect, or specific combinations of these individual aspects.

The above description of example embodiments of the invention has been presented for the purposes of illustration and description. It is not intended to be exhaustive or to limit the invention to the precise form described, and many modifications and variations are possible in light of the teaching above.

A recitation of “a”, “an” or “the” is intended to mean “one or more” unless specifically indicated to the contrary. The use of “or” is intended to mean an “inclusive or,” and not an “exclusive or” unless specifically indicated to the contrary. Reference to a “first” component does not necessarily require that a second component be provided. Moreover reference to a “first” or a “second” component does not limit the referenced component to a particular location unless expressly stated.

All patents, patent applications, publications, and descriptions mentioned herein are incorporated by reference in their entirety for all purposes. None is admitted to be prior art.

What is claimed is:

1. A method of executing a machine learning model on a specialized computing device, the method comprising
obtaining raw input data by a first computing device, the raw input data having a set of dimensions, including (1) a channel dimension having a number C of channels and (2) a first length dimension corresponding to a height or a width of the raw input data;
obtaining, by the first computing device, the machine learning model including a function that applies a set of M model parameters to at least one channel of the raw input data;
determining a configuration parameter K for the specialized computing device by the first computing device, wherein the configuration parameter K corresponds to a data size for which an acceleration path of the specialized computing device operates;
configuring the raw input data based on the configuration parameter K to obtain configured input data, wherein configuring the raw input data includes scaling the number C of channels in the channel dimension by the configuration parameter K and inversely scaling the first length dimension by the configuration parameter K, thereby creating K×C channels;
configuring the machine learning model based on the configuration parameter K to obtain a configured machine learning model with a configured model dimension corresponding to the data size of the acceleration path, wherein configuring the machine learning model includes:
expanding the function to include at least K×M model parameters that are applied to at least K channels;
executing, by the specialized computing device, the configured machine learning model with the configured model parameters using the configured input data to obtain output data; and
providing, by the specialized computing device, the output data.

2. The method of claim 1, further comprising sequencing (i) a nucleic acid molecule obtained from a test sample, using nanopore sequencing, or (ii) a collection of nucleic acid molecules, using florescent microscopy sequencing, to provide the raw input data.

3. The method of claim 1, further comprising pre-processing the raw input data by the first computing device, wherein the pre-processing comprises padding the raw input data to satisfy a dimension based on the configuration parameter K.

4. The method of claim 1, wherein the machine learning model further includes a second function that applies a set of N model parameters to at least one channel of internal data executed by the machine learning model, and wherein configuring the machine learning model further comprises expanding the second function to include at least K×N model parameters that are applied to at least K channels of the internal data.

5. The method of claim 1, wherein the machine learning model is a convolutional neural network (CNN) model.

6. The method of claim 5, wherein the function is a filter having C channels of the CNN model, and wherein expanding the function comprises generating a K×C-channel filter, wherein every C channels of the K×C-channel filter are same as the filter having the C channels, thus the filter having the C channels is replicated K times in the K×C-channel filter.

7. The method of claim 5, wherein the function is a filter having C channels of the CNN model, and wherein expanding the function comprises generating a K×C-channel filter, wherein each channel of the K×C-channel filter has a larger size than a size of each channel of the filter having the C channels, and wherein values of the filter having the C channels is copied to a part of the K×C-channel filter, and other parts of the K×C-channel filter have values equal to zero.

8. The method of claim 1, wherein the specialized computing device is a graphic processing unit (GPU) and the acceleration path is one or more tensor cores.

9. The method of claim 1, wherein the expanding the function comprises replicating the function K times.

10. A computer product comprising a non-transitory computer readable medium storing a plurality of instructions that, when executed, cause a computer system to perform actions comprising:
obtaining raw input data by a first computing device, the raw input data having a set of dimensions, including (1) a channel dimension having a number C of channels and (2) a first length dimension corresponding to a height or a width of the raw input data;
obtaining, by the first computing device, a machine learning model including a function that applies a set of M model parameters to at least one channel of the raw input data;
determining a configuration parameter K for a specialized computing device by the first computing device, wherein the configuration parameter K corresponds to a data size for which an acceleration path of the specialized computing device operates;
configuring the raw input data based on the configuration parameter K to obtain configured input data, wherein configuring the raw input data includes scaling the number C of channels in the channel dimension by the configuration parameter K and inversely scaling the first length dimension by the configuration parameter K, thereby creating K×C channels;
configuring the machine learning model based on the configuration parameter K to obtain a configured machine learning model with a configured model dimension corresponding to the data size of the acceleration path, wherein configuring the machine learning model includes:
expanding the function to include at least K×M model parameters that are applied to at least K channels;
executing, by the specialized computing device, the configured machine learning model with the configured model parameters using the configured input data to obtain output data; and
providing, by the specialized computing device, the output data.

11. The computer product of claim 10, wherein the actions further comprise sequencing (i) a nucleic acid molecule obtained from a test sample, using nanopore sequencing, or (ii) a collection of nucleic acid molecules, using florescent microscopy sequencing, to provide the raw input data.

12. The computer product of claim 10, wherein the machine learning model further includes a second function that applies a set of N model parameters to at least one channel of internal data executed by the machine learning model, and wherein configuring the machine learning model further comprises expanding the second function to include at least K×N model parameters that are applied to at least K channels of the internal data.

13. The computer product of claim 10, wherein the machine learning model is a convolutional neural network (CNN) model.

14. The computer product of claim 13, wherein (i) the function is a filter having C channels of the CNN model, and wherein expanding the function comprises generating a K×C-channel filter, wherein every C channels of the K×C-channel filter are same as the filter having the C channels, thus the filter having the C channels is replicated K times in the K×C-channel filter, or (ii) the function is a filter having C channels of the CNN model, and wherein expanding the function comprises generating a K×C-channel filter, wherein each channel of the K×C-channel filter has a larger size than a size of each channel of the filter having the C channels, and wherein values of the filter having the C channels is copied to a part of the K×C-channel filter, and other parts of the K×C-channel filter have values equal to zero.

15. The computer product of claim 10, wherein the specialized computing device is a graphic processing unit (GPU) and the acceleration path is one or more tensor cores.

16. A system comprising:
one or more processors; and
one or more computer-readable media storing instructions which, when executed by the one or more processors, cause the system to perform actions comprising:
obtaining raw input data by a first computing device, the raw input data having a set of dimensions, including (1) a channel dimension having a number C of channels and (2) a first length dimension corresponding to a height or a width of the raw input data;
obtaining, by the first computing device, a machine learning model including a function that applies a set of M model parameters to at least one channel of the raw input data;
determining a configuration parameter K for a specialized computing device by the first computing device, wherein the configuration parameter K corresponds to a data size for which an acceleration path of the specialized computing device operates;
configuring the raw input data based on the configuration parameter K to obtain configured input data, wherein configuring the raw input data includes scaling the number C of channels in the channel dimension by the configuration parameter K and inversely scaling the first length dimension by the configuration parameter K, thereby creating K×C channels;
configuring the machine learning model based on the configuration parameter K to obtain a configured machine learning model with a configured model dimension corresponding to the data size of the acceleration path, wherein configuring the machine learning model includes:
expanding the function to include at least K×M model parameters that are applied to at least K channels;
executing, by the specialized computing device, the configured machine learning model with the configured model parameters using the configured input data to obtain output data; and
providing, by the specialized computing device, the output data.

17. The system of claim 16, wherein the actions further comprise sequencing (i) a nucleic acid molecule obtained from a test sample, using nanopore sequencing, or (ii) a collection of nucleic acid molecules, using florescent microscopy sequencing, to provide the raw input data.

18. The system of claim 16, wherein the machine learning model further includes a second function that applies a set of N model parameters to at least one channel of internal data executed by the machine learning model, and wherein configuring the machine learning model further comprises expanding the second function to include at least K×N model parameters that are applied to at least K channels of the internal data.

19. The system of claim 16, wherein the machine learning model is a convolutional neural network (CNN) model.

20. The system of claim 19, wherein (i) the function is a filter having C channels of the CNN model, and wherein expanding the function comprises generating a K×C-channel filter, wherein every C channels of the K×C-channel filter are same as the filter having the C channels, thus the filter having the C channels is replicated K times in the K×C-channel filter, or (ii) the function is a filter having C channels of the CNN model, and wherein expanding the function comprises generating a K×C-channel filter, wherein each channel of the K×C-channel filter has a larger size than a size of each channel of the filter having the C channels, and wherein values of the filter having the C channels is copied to a part of the K×C-channel filter, and other parts of the K×C-channel filter have values equal to zero.
